(19) United States
(12) Patent Application Publication
(10) Pub. No.: US 2026/0365218 A1
(43) Pub. Date: Nov. 19, 2026

(54) BABY STROLLER FRAME

(71) Applicant: Seedling(Huangshi)Baby Product Co., Ltd., Huangshi (CN)

(72) Inventors: Zhenji ZHENG, Huangshi (CN); Jianxin LV, Huangshi (CN)

(21) Appl. No.: 19/425,947

(22) Filed: Dec. 18, 2025

(30) Foreign Application Priority Data
May 19, 2025 (CN) 202510643437.5

(51) Int. Cl. B62B 7/06; B62B 7/08

(52) U.S. Cl. CPC B62B 7/062; B62B 7/064; B62B 7/083; B62B 2205/20

(57) ABSTRACT

Disclosed is a baby stroller frame, including a bottom support frame and a seat frame, the seat frame being rotatably connected to the first connecting seat around a third axis, a transmission rod being further provided and hinged between the seat frame and the push rod assembly, the transmission rod being configured to drive the seat frame to rotate towards the first support leg to close up when the push rod assembly rotates towards the bottom support frame to close up. Therefore, the baby stroller frame provides a simple structure, flexible folding, and a small volume after folding.

### CROSS REFERENCE TO RELATED APPLICATIONS

The present disclosure claims the priority of Chinese Patent Application No. 2025106434375 filed on May 19, 2025 before CNIPA. All the above are hereby incorporated by reference in their entirety.

### TECHNICAL FIELD

The present disclosure relates to the technical field of baby strollers, and in particular, to a baby stroller frame.

### BACKGROUND

A baby stroller is a common product during the growth process of infants and young children. Current baby strollers are generally capable of being unfolded or folded. In the unfolded state, the baby strollers are used for children to sit and travel, while in the folded state, the baby strollers are convenient for carrying or storage.

The baby stroller frame is an important component of a baby stroller, and the structure thereof determines whether the baby stroller unfolds or folds smoothly, and also determines the space occupied by the baby stroller after folding. Currently, baby stroller frames on the market have various structures and are not the same. Therefore, the present disclosure provides a new baby stroller frame different from the prior art.

### SUMMARY

An objective of the present disclosure is to overcome the deficiencies of the prior art and to provide a baby stroller frame with a simple structure, flexible folding, and a small volume after folding.

A baby stroller frame according to the present disclosure, movable from an unfolded position to a folded position after a locking device is unlocked, includes a bottom support frame, where the bottom support frame includes a first support leg and a second support leg, lower ends of the first support leg and the second support leg are each provided with a wheel, an upper end of the first support leg is provided with a first connecting seat, an upper end of the second support leg is rotatably connected to the first connecting seat around a first axis, an upper end of the bottom support frame is rotatably connected with a push rod assembly, a linkage assembly is provided between the push rod assembly and the bottom support frame, and the linkage assembly is configured to drive the first support leg and the second support leg to rotate towards each other to close up when the push rod assembly rotates towards the bottom support frame to close up; the baby stroller frame further includes a seat frame, where the seat frame is rotatably connected to the first connecting seat around a third axis, a transmission rod is further provided and hinged between the seat frame and the push rod assembly, and the transmission rod is configured to drive the seat frame to rotate towards the first support leg to close up when the push rod assembly rotates towards the bottom support frame to close up.

The push rod assembly includes a second connecting seat rotatably connected to the first connecting seat around a fourth axis, a lower push rod is fixedly connected to the second connecting seat, and a hand push rod is connected to the lower push rod and configured to move relative thereto.

An end of the transmission rod is hinged to the seat frame around a fifth axis, and an opposite end thereof is hinged to the second connecting seat around a sixth axis.

The seat frame includes a seat rod and an extension seat fixed to the seat rod and extending obliquely downward, and the extension seat is rotatably connected to the first connecting seat around the third axis.

The baby stroller frame further includes an armrest, where the armrest is rotatably connected to the second connecting seat around the sixth axis.

The armrest is rotatably connected to the transmission rod, the armrest is provided with a receiving slot, an upper end of the transmission rod extends into the receiving slot and is hinged to the second connecting seat, the receiving slot is provided a first side wall and a second side wall, and the first side wall abuts against a side of the transmission rod and the second side wall abuts against an opposite side of the transmission rod to position the armrest when the baby stroller frame is in the unfolded position, and the receiving slot is further provided with a third side wall, and the armrest rotates relative to the transmission rod to reach a position where the third side wall abuts against the transmission rod during a movement of the baby stroller frame from the unfolded position to the folded position.

The second connecting seat is provided with a limiting step, the armrest is provided with an abutting surface configured to abut against the limiting step, and the limiting step abuts against the abutting surface when the baby stroller frame is in the unfolded position.

The linkage assembly includes a first linkage rod, a second linkage rod, and a third linkage rod, one end of the first linkage rod is hinged to the first support leg around a seventh axis, the other end of the first linkage rod is hinged to the second linkage rod around an eighth axis, an end of the second linkage rod away from the first linkage rod is hinged to the second support leg around a ninth axis, an upper end of the third linkage rod is hinged to the second connecting seat around a tenth axis and is offset from the fourth axis, and a lower end of the third linkage rod is hinged to the first linkage rod or the second linkage rod around the eighth axis.

The locking device includes a plurality of first locking grooves provided on the first connecting seat in a circumferential direction, a plurality of second locking grooves provided on the second connecting seat in a circumferential direction, a locking gear is provided within a space enclosed by the first connecting seat and the second connecting seat and is configured to move laterally and simultaneously engage with the plurality of first locking grooves and the plurality of second locking grooves, a movable block is provided between the locking gear and the second connecting seat and is configured to rotate and move laterally when rotating to push the locking gear to disengage from the plurality of second locking grooves, and a first return spring is further provided between the locking gear and the first connecting seat and is configured to push the locking gear to reset laterally.

The hand push rod is slidably connected to the lower push rod, a locking member is provided between the hand push rod and the lower push rod and is configured to lock the hand push rod and the lower push rod, a sliding rod is provided in the second connecting seat and is configured to be pushed by the hand push rod when the hand push rod retracts into the lower push rod, a lower end of the sliding rod is provided with a pushing portion configured to push the movable block to rotate when the sliding rod slides downward, a plurality of oblique slots are provided on the movable block in a circumferential direction, an oblique protrusion is provided on the second connecting seat and cooperates with the plurality of oblique slots and is configured to push the movable block to move laterally when the movable block rotates, and a second return spring is further provided in the second connecting seat and is configured to push the sliding rod to reset.

Compared with the prior art, the present disclosure provides the following advantages:
1. When the baby stroller frame of the present disclosure is folded, during the process where the push rod assembly rotates towards the bottom support frame to close up, the linkage assembly drives the first support leg and the second support leg to rotate relative to each other to close up. Moreover, during this process, the push rod assembly pushes against the transmission rod to rotate relative to the transmission rod, and the transmission rod then pushes against the seat frame to cause the seat frame to rotate relative to the first connecting seat, thereby leading to the seat frame also folding towards the first support leg to close up. The entire baby stroller frame provides a simple and compact structure, unfolds or folds smoothly and flexibly, and provides a small volume after folding, making it easy to carry or store, and is suitable for popularization and application.
2. The baby stroller frame of the present disclosure further includes an armrest for a child to grip to ensure safety. The armrest, the transmission rod, and the second connecting seat are rotatably connected to each other. When the baby stroller frame is in the unfolded position, the first side wall and the second side wall on the armrest abut against two sides of the transmission rod. At this time, the transmission rod may position the armrest, causing the armrest to stay in the unfolded position for the child to grip. When the baby stroller frame moves from the unfolded position to the folded position, the armrest, the transmission rod, and the second connecting seat rotate relative to each other, and the third side wall on the armrest gradually abuts against one side of the transmission rod, enabling the armrest to be folded and stored compactly.
3. The seat frame of the present disclosure includes a seat rod and an extension seat fixed to the seat rod. The extension seat extends obliquely downward and is rotatably connected to the first connecting seat. Therefore, while ensuring the simple and compact structure of the baby stroller frame, smooth folding or unfolding of the seat frame is also ensured.

### BRIEF DESCRIPTION OF THE DRAWINGS

FIG. 1 is a perspective view of the present disclosure;

FIG. 2 is another perspective view of the present disclosure;

FIG. 3 is an enlarged view of portion B in FIG. 2;

FIG. 4 is a side view of the present disclosure;

FIG. 5 is a perspective view of the present disclosure during folding;

FIG. 6 is a side view of the present disclosure in a folding process;

FIG. 7 is a side view of the present disclosure in a folded position;

FIG. 8 is a perspective view of components of the present disclosure;

FIG. 9 is another perspective view of components of the present disclosure;

FIG. 10 is a partial cross-sectional view of the present disclosure;

FIG. 11 is an exploded view of components of the present disclosure;

FIG. 12 is another exploded view of components of the present disclosure.

### DETAILED DESCRIPTION

The following further explains the present disclosure in conjunction with the accompanying drawings:

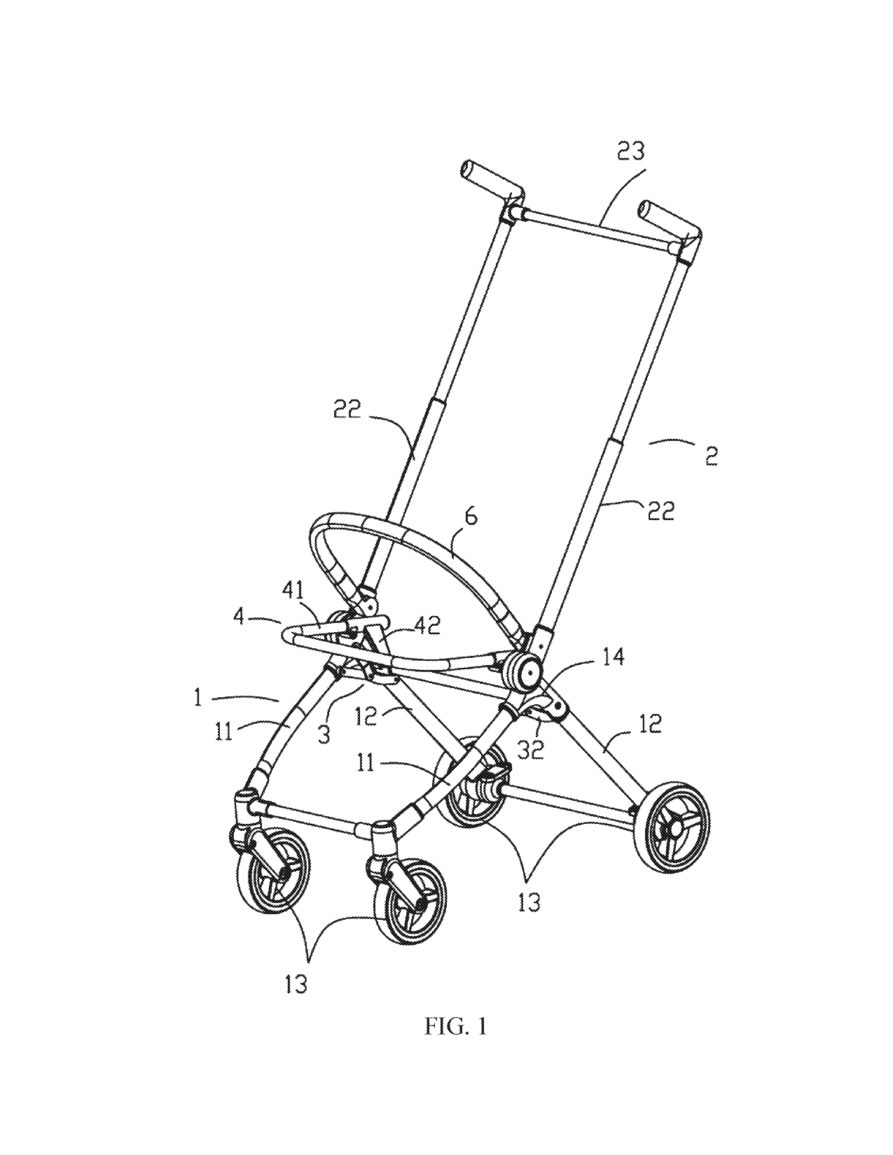

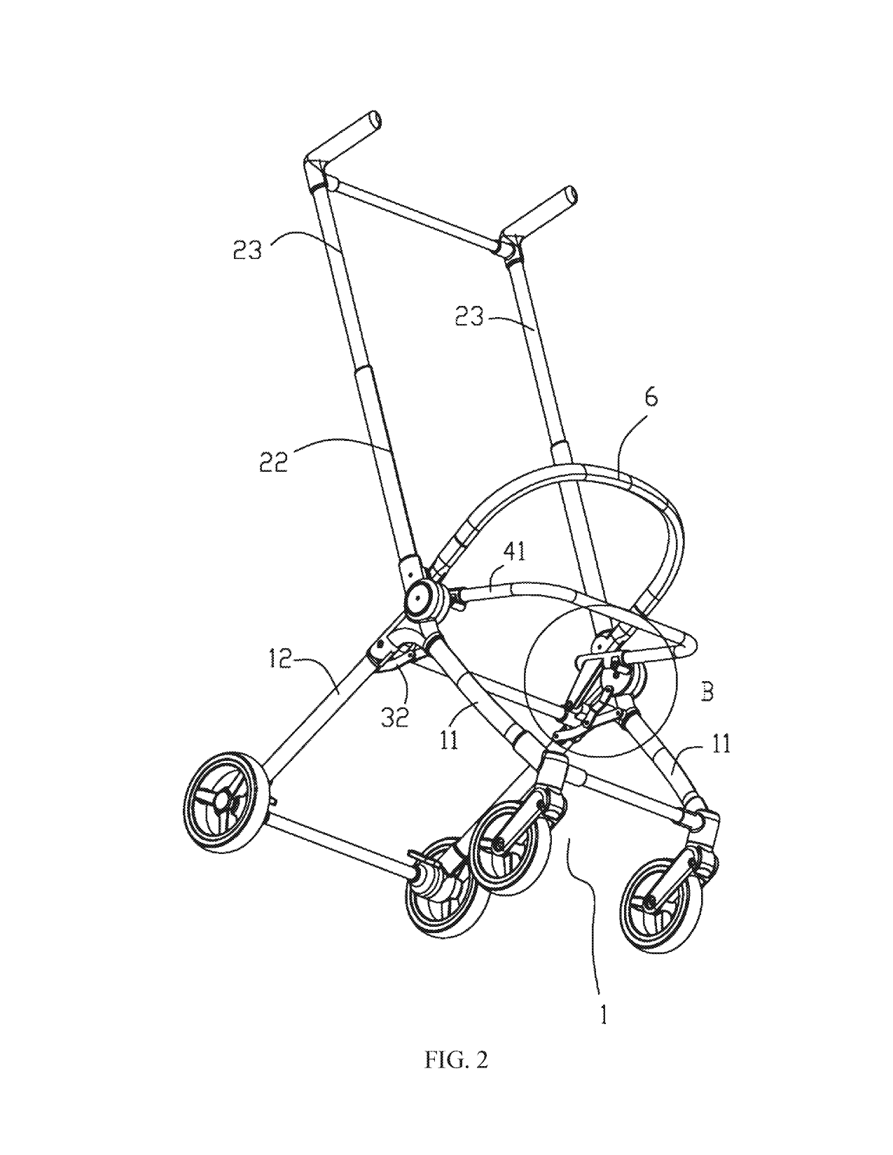

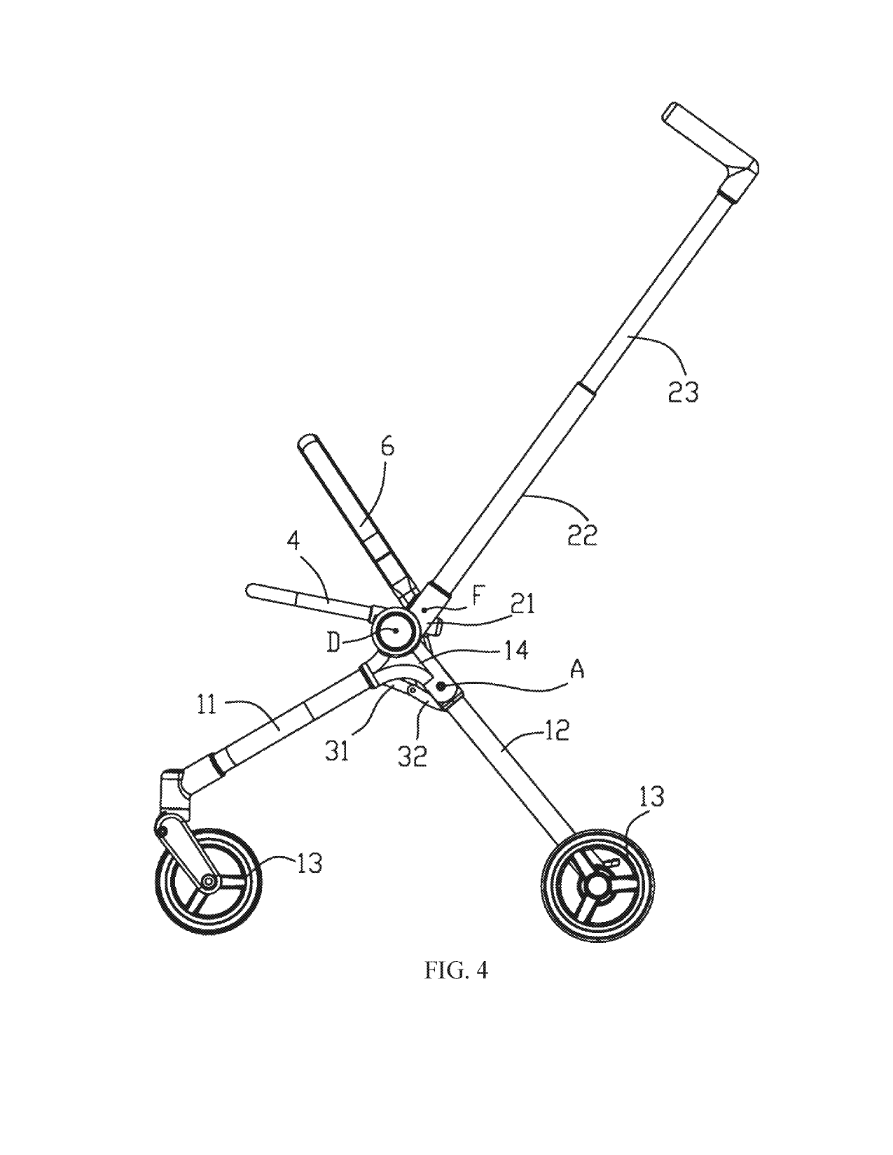

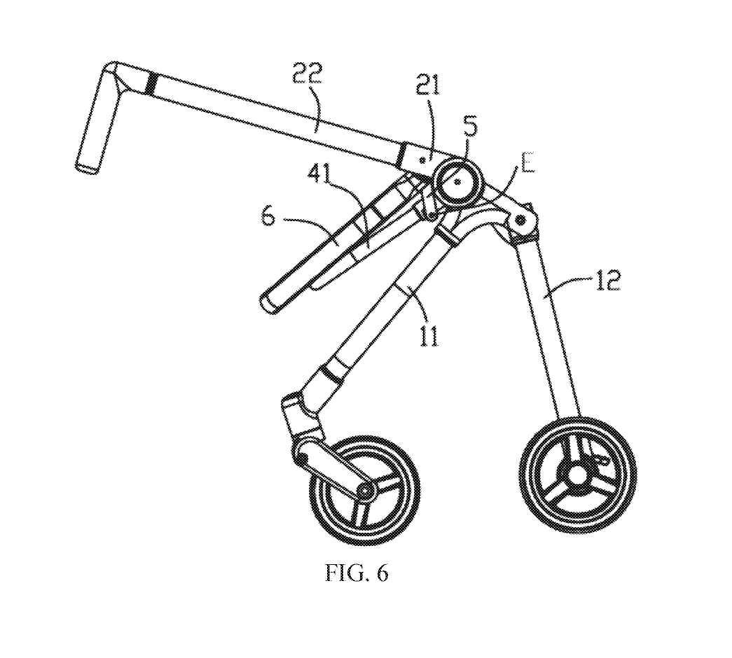

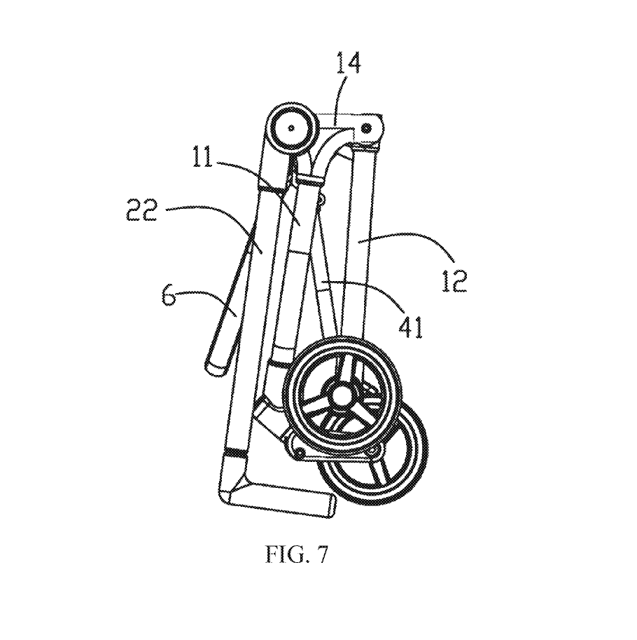

As shown in FIGS. 1-7, a baby stroller frame according to the present disclosure is movable from an unfolded position to a folded position after a locking device is unlocked. The unfolded position as shown in FIG. 1 is used for a baby to sit. Admittedly, when the baby stroller frame is used as a baby stroller, a seat cushion and the like need to be added for the baby to sit comfortably. In the folded position as shown in FIG. 7, it is convenient for a user to carry or store, for example, the baby stroller frame may be placed in a car trunk for carrying during travel, or the baby stroller frame may be carried by hanging on the shoulder with a strap.

As shown in FIGS. 1-7, the baby stroller frame includes a bottom support frame 1. The bottom support frame 1 may be unfolded or folded and is configured to support on the ground to provide effective support. Specifically, the bottom support frame 1 includes a first support leg 11 and a second support leg 12. Lower ends of the first support leg 11 and the second support leg 12 are each provided with a wheel 13. An upper end of the first support leg 11 is provided with a first connecting seat 14. An upper end of the second support leg 12 is rotatably connected to the first connecting seat 14 around a first axis A. An upper end of the bottom support frame 1 is rotatably connected with a push rod assembly 2. A linkage assembly 3 is provided between the push rod assembly 2 and the bottom support frame 1, and the linkage assembly 3 is configured to drive the first support leg 11 and the second support leg 12 to rotate towards each other to close up when the push rod assembly 2 rotates towards the bottom support frame 1 to close up. When the baby stroller frame is folded, the locking device is first unlocked, and then during a process where the push rod assembly 2 rotates towards the bottom support frame 1 to close up, the linkage assembly 3 drives the first support leg 11 and the second support leg 12 to rotate relative to each other to close up, thereby leading to the bottom support frame 1 also being linked to fold when the push rod assembly 2 rotates to fold, thus simplifying the folding operation. The locking device may adopt a traditional engagement structure of a snap-pin and a snap-hole, or may adopt a locking device with a specific structure in the embodiment. The specific structure of the locking device in the present embodiment will be described in detail later.

As shown in FIGS. 1-7, the baby stroller frame further includes a seat frame 4. The seat frame 4 is configured to support a seat for a baby to sit. The seat frame 4 is rotatably connected to the first connecting seat 14 around a third axis C. A transmission rod 5 is further provided and hinged between the seat frame 4 and the push rod assembly 2, and the transmission rod 5 is configured to drive the seat frame 4 to rotate towards the first support leg 11 to close up when the push rod assembly 2 rotates towards the bottom support frame 1 to close up. During a folding process where the push rod assembly 2 rotates relative to the bottom support frame 1, the push rod assembly 2 pushes against the transmission rod 5 to rotate relative to the transmission rod 5, and the transmission rod 5 pushes against the seat frame 4 to cause the seat frame 4 to rotate relative to the first connecting seat 14, thereby leading to the seat frame 4 also folding towards the first support leg 11 to close up. Therefore, the bottom support frame 1 itself and the seat frame 4 are linked to fold together as long as the push rod assembly 2 rotates relative to the bottom support frame 1 to fold, making the entire folding operation very simple and quick. Moreover, the entire baby stroller frame provides a simple and compact structure, unfolds or folds smoothly and flexibly, and provides a small volume after folding, making it easy to carry or store.

As shown in FIGS. 1 and 2, and 4-7, the push rod assembly 2 includes a second connecting seat 21 rotatably connected to the first connecting seat 14 around a fourth axis D. A lower push rod 22 is fixedly connected to the second connecting seat 21, and a hand push rod 23 is connected to the lower push rod 22 and configured to move relative thereto. The hand push rod 23 may be configured to be rotatably connected to the lower push rod 22 to be unfolded or folded, or may be configured to slide and extend relative to the lower push rod 22. In the present embodiment, the hand push rod 23 is slidably disposed in the lower push rod 22. When unfolding, the hand push rod 23 is pulled out, and when folding, the hand push rod 23 is retracted deeper into the lower push rod 22.

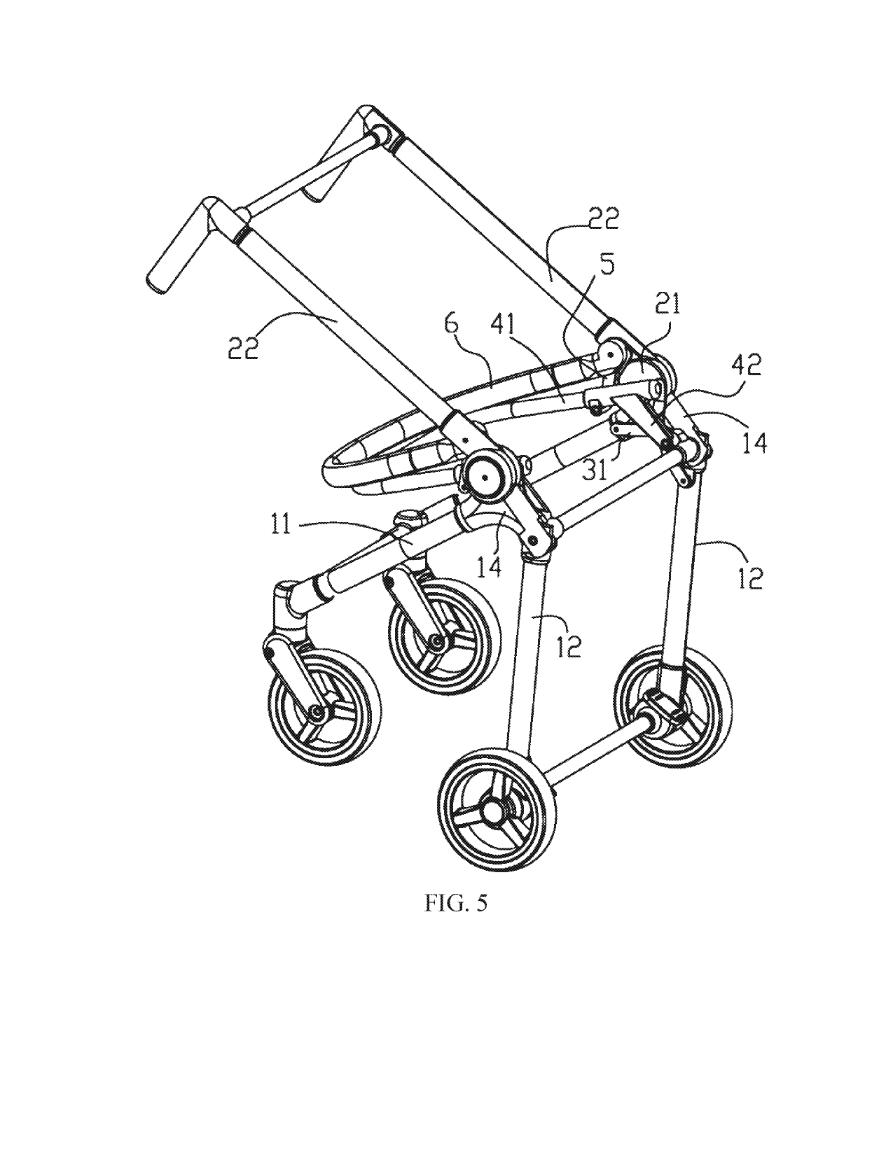

As shown in FIGS. 5, 6, 10 and 11, an end of the transmission rod 5 is hinged to the seat frame 4 around a fifth axis E, and an opposite end thereof is hinged to the second connecting seat 21 around a sixth axis F.

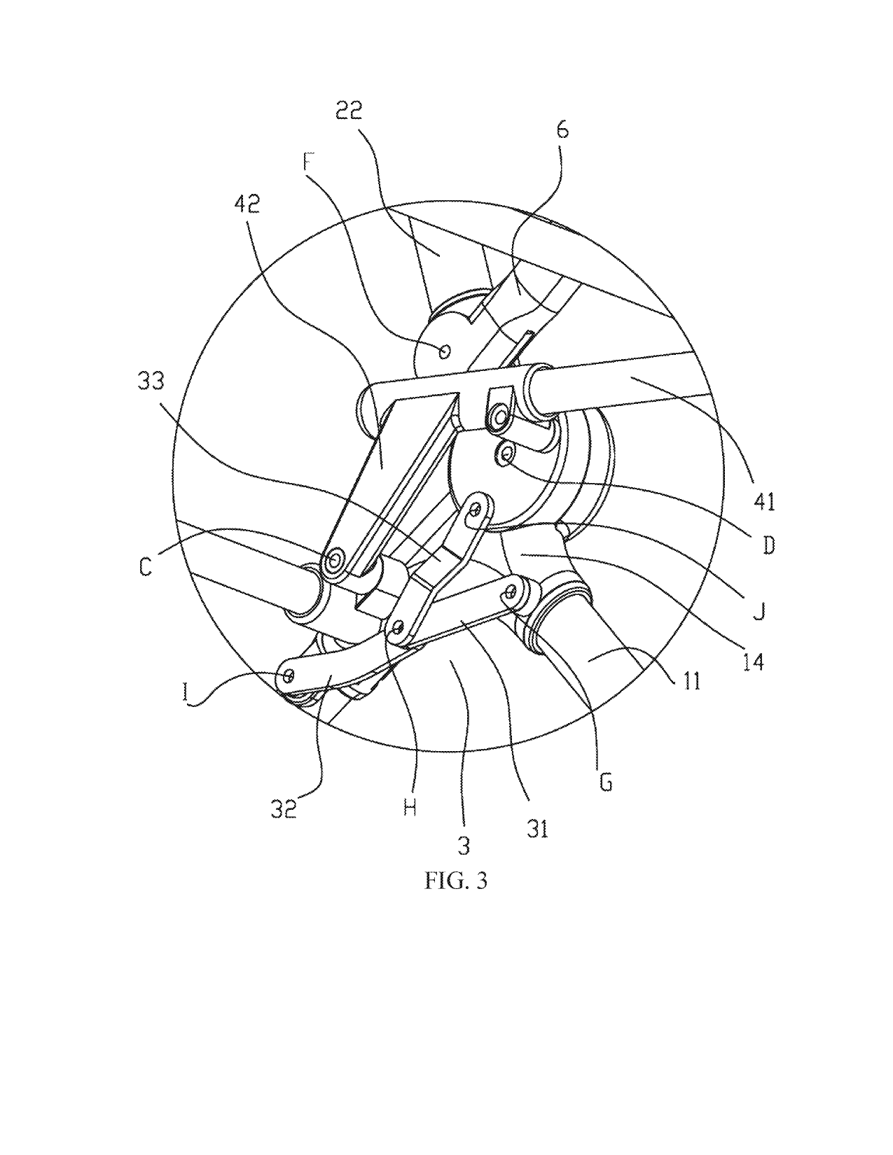

As shown in FIGS. 3, 5 and 11, the seat frame 4 includes a seat rod 41 and an extension seat 42 fixed to the seat rod 41 and extending obliquely downward. The extension seat 42 is rotatably connected to the first connecting seat 14 around the third axis C. This ensures smooth folding or unfolding of the seat frame 4 while also ensuring a simple and compact structure for the baby stroller frame.

The baby stroller frame of the present embodiment further includes an armrest 6 for a child to grip, ensuring safety. The armrest 6 is rotatably connected to the second connecting seat 21 around the sixth axis F.

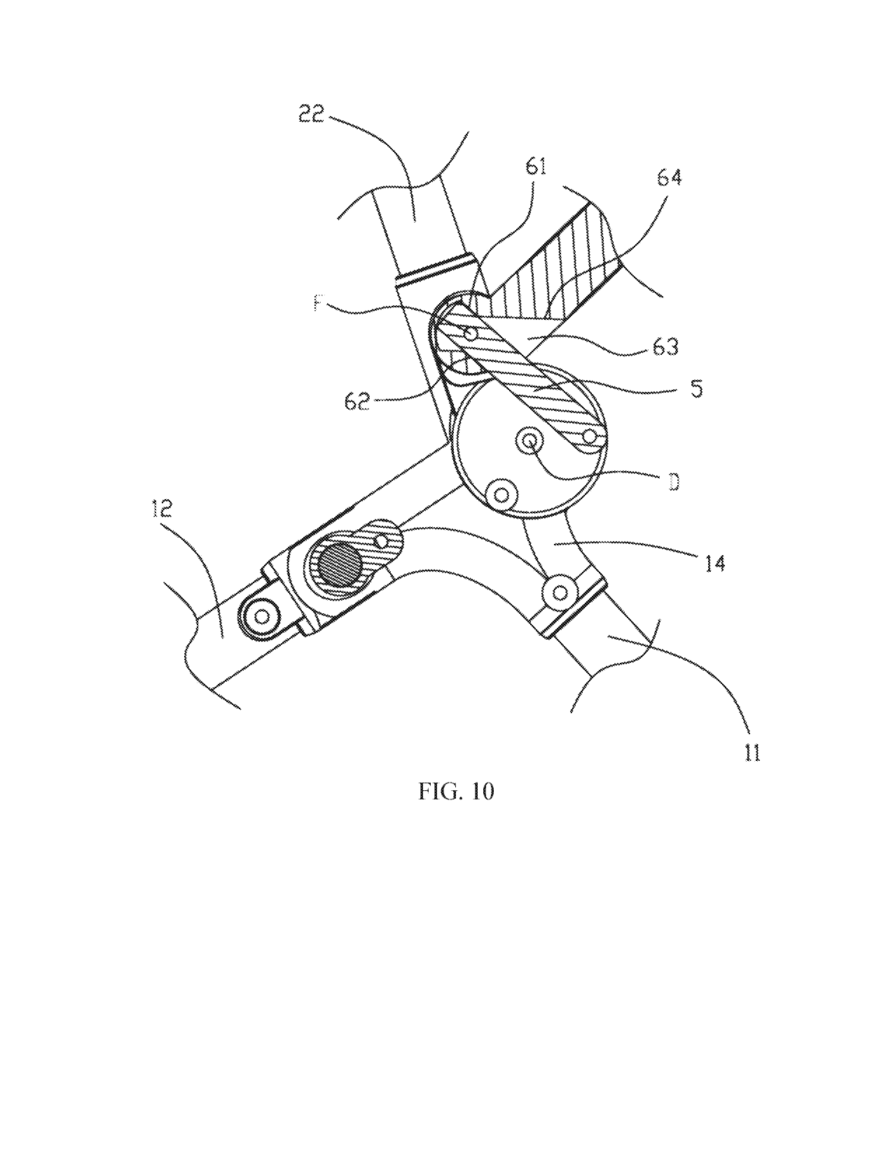

As shown in FIG. 10, the armrest 6 is rotatably connected to the transmission rod 5. The armrest 6 is provided with a receiving slot 63. An upper end of the transmission rod 5 extends into the receiving slot 63 and is hinged to the second connecting seat 21. The receiving slot 63 has a first side wall 61 and a second side wall 62. When the baby stroller frame is in the unfolded position, the first side wall 61 abuts against a side of the transmission rod 5 and the second side wall 62 abuts against an opposite side of the transmission rod 5 to position the armrest 6. The receiving slot 63 is further provided with a third side wall 64. During a movement of the baby stroller frame from the unfolded position to the folded position, the armrest 6 rotates relative to the transmission rod 5 to reach a position where the third side wall 64 abuts against the transmission rod 5. The upper end of the transmission rod 5 is inserted into an interior of the armrest 6 from the receiving slot 63, facilitating easy assembly and contributing to a simple and compact structure of the baby stroller frame. When the baby stroller frame is in the unfolded position, the armrest 6 is positioned by the abutment of the first side wall 61 against one side of the transmission rod 5 and the abutment of the second side wall 62 against the other side of the transmission rod 5, causing the armrest 6 to remain in the unfolded position for the child to grip. When the baby stroller frame is folded, the armrest 6 may rotate relative to the transmission rod 5 until the third side wall 64 abuts against the transmission rod 5, enabling the armrest 6 to be folded and stored compactly.

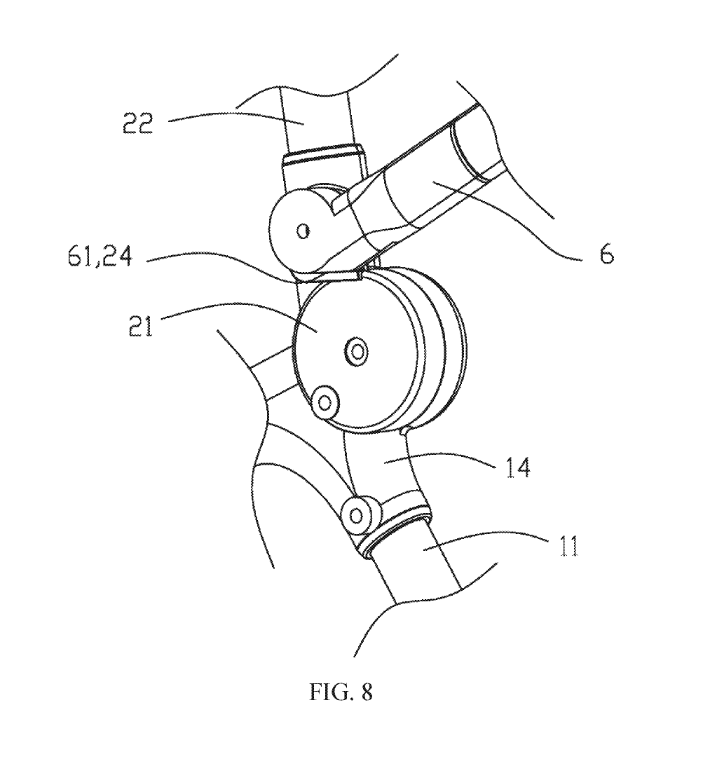

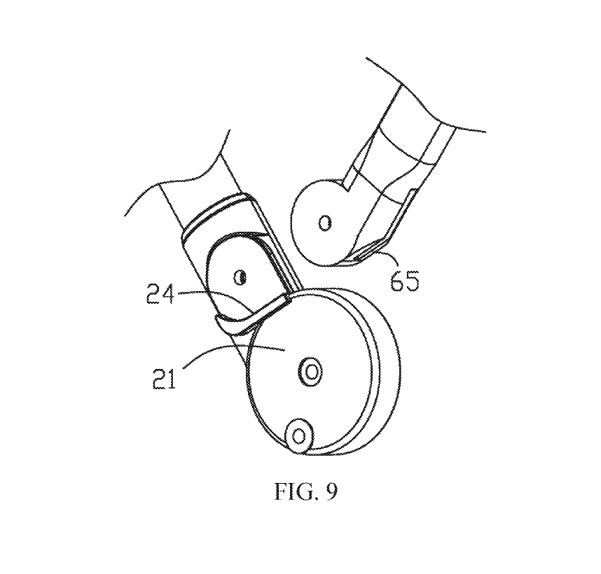

As shown in FIGS. 8 and 9, the second connecting seat 21 is provided with a limiting step 24. The armrest 6 is provided with an abutting surface 65 configured to abut against the limiting step 24. When the baby stroller frame is in the unfolded position, the limiting step 24 abuts against the abutting surface 65 to limit the position of the armrest 6, ensuring that the armrest 6 remains in the unfolded position.

As shown in FIGS. 1, 3 and 12, the linkage assembly 3 includes a first linkage rod 31, a second linkage rod 32, and a third linkage rod 33. An end of the first linkage rod 31 is hinged to the first support leg 11 around a seventh axis G. An opposite end of the first linkage rod 31 is hinged to the second linkage rod 32 around an eighth axis H. An end of the second linkage rod 32 away from the first linkage rod 31 is hinged to the second support leg 12 around a ninth axis I. An upper end of the third linkage rod 33 is hinged to the second connecting seat 21 around a tenth axis J and is offset from the fourth axis D. A lower end of the third linkage rod 33 is hinged to the first linkage rod 31 or the second linkage rod 32 around the eighth axis H. When the push rod assembly 2 rotates to fold, the second connecting seat 21 rotates relative to the first connecting seat 14 around the fourth axis D. At this time, the position of the second connecting seat 21 offset from the fourth axis D pulls the third linkage rod 33 upward and rotates relative to the third linkage rod 33. The third linkage rod 33 then pulls the connection position of the first linkage rod 31 and the second linkage rod 32 to move upward. The lower ends of the first linkage rod 31 and the second linkage rod 32 then pull the first support leg 11 and the second support leg 12 to rotate towards each other to close up.

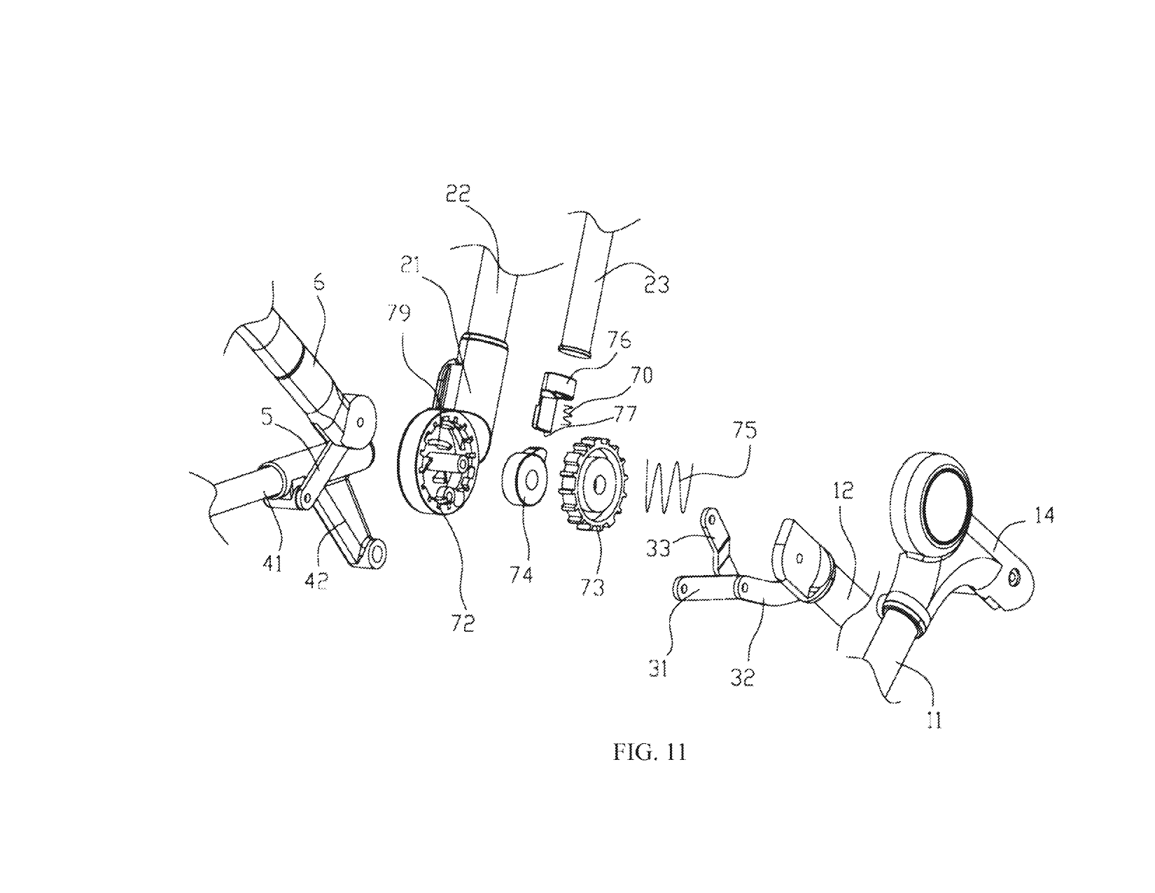

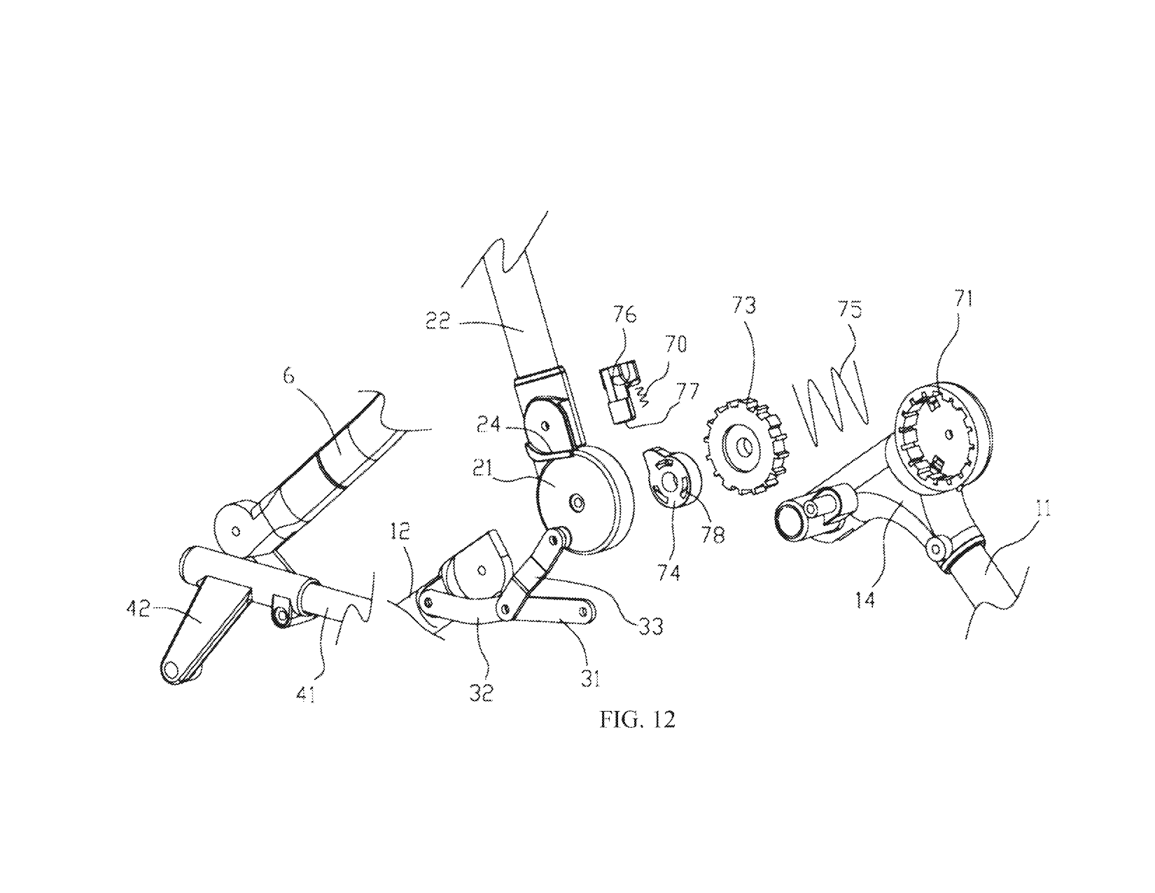

As shown in FIGS. 11 and 12, the locking device includes a plurality of first locking grooves 71 provided on the first connecting seat 14 in a circumferential direction. A plurality of second locking grooves 72 are provided on the second connecting seat 21 in a circumferential direction. A locking gear 73 is provided within a space enclosed by the first connecting seat 14 and the second connecting seat 21 and is configured to move laterally and simultaneously engage with the plurality of first locking grooves 71 and the plurality of second locking grooves 72. A movable block 74 is provided between the locking gear 73 and the second connecting seat 21 and is configured to rotate and move laterally when rotating to push the locking gear 73 to disengage from the plurality of second locking grooves 72. A first return spring 75 is further provided between the locking gear 73 and the first connecting seat 14 and is configured to push the locking gear 73 to reset laterally. When unlocking is required, the movable block 74 is rotated. During the rotation process, the movable block 74 pushes the locking gear 73 to move laterally to disengage from the plurality of second locking grooves 72. Once the locking gear 73 is disengaged from the plurality of second locking grooves 72, the push rod assembly 2 may be pushed forward to cause the second connecting seat 21 to rotate relative to the first connecting seat 14, thereby achieving folding of the baby stroller frame. When the baby stroller is in the unfolded position, the plurality of second locking grooves 72 and the plurality of first locking grooves 71 simultaneously engage with the locking gear 73, and the first return spring 75 provides a certain holding thrust to the locking gear 73, thereby maintaining the baby stroller frame in the unfolded position. In the present embodiment, the hand push rod 23 is slidably connected to the lower push rod 22. When folding the baby stroller frame, the hand push rod 23 is first retracted deep into the lower push rod 22. A locking member (not shown in the figures) is provided between the hand push rod 23 and the lower push rod 22 and is configured to lock the hand push rod 23 and the lower push rod 22. The locking member may adopt the engagement of a snap-pin and a snap-hole in a traditional structure, which is not repeated herein.

As shown in FIGS. 11 and 12, a sliding rod 76 is provided in the second connecting seat 21 and is configured to be pushed by the hand push rod 23 when the hand push rod 23 retracts into the lower push rod 22. A lower end of the sliding rod 76 is provided with a pushing portion 77 configured to push the movable block 74 to rotate when the sliding rod 76 slides downward. A plurality of oblique slots 78 are provided on the movable block 74 in a circumferential direction. An oblique protrusion 79 is provided on the second connecting seat 21 and cooperates with the plurality of oblique slots 78 and is configured to push the movable block 74 to move laterally when the movable block 74 rotates. A second return spring 70 is further provided in the second connecting seat 21 and is configured to push the sliding rod 76 to reset. When the hand push rod 23 is retracted deep into the lower push rod 22, a lower end of the hand push rod 23 pushes the sliding rod 76 to slide downward. The pushing portion 77 at the lower end of the sliding rod 76 then pushes the movable block 74 to rotate. A bottom of the plurality of oblique slots 78 on the movable block 74 slides relative to the oblique protrusion 79 on the second connecting seat 21. The oblique protrusion 79 then pushes the movable block 74 to move laterally, thereby pushing the locking gear 73 to disengage from the second locking grooves 72 to unlock. At this time, the push rod assembly 2 may be rotated to achieve folding of the baby stroller frame.

What is claimed is:

1. A baby stroller frame, movable from an unfolded position to a folded position after a locking device is unlocked, comprising a bottom support frame, wherein the bottom support frame comprises a first support leg and a second support leg, lower ends of the first support leg and the second support leg are each provided with a wheel, an upper end of the first support leg is provided with a first connecting seat, an upper end of the second support leg is rotatably connected to the first connecting seat around a first axis A, an upper end of the bottom support frame is rotatably connected with a push rod assembly, a linkage assembly is provided between the push rod assembly and the bottom support frame, and the linkage assembly is configured to drive the first support leg and the second support leg to rotate towards each other to close up when the push rod assembly rotates towards the bottom support frame to close up; the baby stroller frame further comprises a seat frame, wherein the seat frame is rotatably connected to the first connecting seat around a third axis C, a transmission rod is further provided and hinged between the seat frame and the push rod assembly, and the transmission rod is configured to drive the seat frame to rotate towards the first support leg to close up when the push rod assembly rotates towards the bottom support frame to close up;
during a folding process where the push rod assembly rotates relative to the bottom support frame, the push rod assembly pushes against the transmission rod to rotate relative to the transmission rod, and the transmission rod pushes against the seat frame to cause the seat frame to rotate relative to the first connecting seat, leading to the seat frame also folding towards the first support leg to close up, so that the bottom support frame and the seat frame are linked to fold together as long as the push rod assembly rotates relative to the bottom support frame to fold.

2. The baby stroller frame according to claim 1, wherein the push rod assembly comprises a second connecting seat rotatably connected to the first connecting seat around a fourth axis D, a lower push rod is fixedly connected to the second connecting seat, and a hand push rod is connected to the lower push rod and configured to move relative thereto.

3. The baby stroller frame according to claim 2, wherein an end of the transmission rod is hinged to the seat frame around a fifth axis E, and an opposite end thereof is hinged to the second connecting seat around a sixth axis F.

4. The baby stroller frame according to claim 2, wherein the seat frame comprises a seat rod and an extension seat fixed to the seat rod and extending obliquely downward, and the extension seat is rotatably connected to the first connecting seat around the third axis C.

5. The baby stroller frame according to claim 2, further comprising an armrest, wherein the armrest is rotatably connected to the second connecting seat around the sixth axis F.

6. The baby stroller frame according to claim 5, wherein the armrest is rotatably connected to the transmission rod, the armrest is provided with a receiving slot, an upper end of the transmission rod extends into the receiving slot and is hinged to the second connecting seat, the receiving slot is provided a first side wall and a second side wall, and the first side wall abuts against a side of the transmission rod and the second side wall abuts against an opposite side of the transmission rod to position the armrest when the baby stroller frame is in the unfolded position, and the receiving slot is further provided with a third side wall, and the armrest rotates relative to the transmission rod to reach a position where the third side wall abuts against the transmission rod during a movement of the baby stroller frame from the unfolded position to the folded position.

7. The baby stroller frame according to claim 6, wherein the second connecting seat is provided with a limiting step, the armrest is provided with an abutting surface configured to abut against the limiting step, and the limiting step abuts against the abutting surface when the baby stroller frame is in the unfolded position.

8. The baby stroller frame according to claim 2, wherein the linkage assembly comprises a first linkage rod, a second linkage rod, and a third linkage rod, one end of the first linkage rod is hinged to the first support leg around a seventh axis G, the other end of the first linkage rod is hinged to the second linkage rod around an eighth axis H, an end of the second linkage rod away from the first linkage rod is hinged to the second support leg around a ninth axis I, an upper end of the third linkage rod is hinged to the second connecting seat around a tenth axis J and is offset from the fourth axis D, and a lower end of the third linkage rod is hinged to the first linkage rod or the second linkage rod around the eighth axis H.

9. The baby stroller frame according to claim 2, wherein the locking device comprises a plurality of first locking grooves provided on the first connecting seat in a circumferential direction, a plurality of second locking grooves provided on the second connecting seat in a circumferential direction, a locking gear is provided within a space enclosed by the first connecting seat and the second connecting seat and is configured to move laterally and simultaneously engage with the plurality of first locking grooves and the plurality of second locking grooves, a movable block is provided between the locking gear and the second connecting seat and is configured to rotate and move laterally when rotating to push the locking gear to disengage from the plurality of second locking grooves, and a first return spring is further provided between the locking gear and the first connecting seat and is configured to push the locking gear to reset laterally.

10. The baby stroller frame according to claim 9, wherein the hand push rod is slidably connected to the lower push rod, a locking member is provided between the hand push rod and the lower push rod and is configured to lock the hand push rod and the lower push rod, a sliding rod is provided in the second connecting seat and is configured to be pushed by the hand push rod when the hand push rod retracts into the lower push rod, a lower end of the sliding rod is provided with a pushing portion configured to push the movable block to rotate when the sliding rod slides downward, a plurality of oblique slots are provided on the movable block in a circumferential direction, an oblique protrusion is provided on the second connecting seat and cooperates with the plurality of oblique slots and is configured to push the movable block to move laterally when the movable block rotates, and a second return spring is further provided in the second connecting seat and is configured to push the sliding rod to reset.
